(19) United States
(12) Patent Application Publication
(10) Pub. No.: US 2016/0180984 A1
(43) Pub. Date: Jun. 23, 2016

(54) SINGLE-SIDED HOT-MELT ALUMINUM-PLASTIC COMPOSITE FOIL AND PREPARATION METHOD THEREOF

(71) Applicant: HANGZHOU LINAN TIANHONG TELECOMMUNICATION MATERIAL CO., LTD., HANGZHOU (CN)

(72) Inventor: SHENGYUE CAI, HANGZHOU (CN)

(21) Appl. No.: 14/672,453

(22) Filed: Mar. 30, 2015

(30) Foreign Application Priority Data
Dec. 18, 2014 (CN) 201410795091.2

(51) Int. Cl. H01B 3/42; B32B 7/12; B32B 15/09; B32B 15/20; B29C 65/02; B29C 65/48

(52) U.S. Cl. CPC H01B 3/421; B29C 65/02; B29C 65/48; B32B 15/09; B32B 15/20; B32B 7/12; B29L 2031/711

(57) ABSTRACT

A single-sided hot-melt aluminum-plastic composite foil and a preparation method thereof is provided, the single-sided hot-melt aluminum-plastic composite foil comprises an aluminum foil layer and a PET film layer, the aluminum foil layer and the PET film layer are bonded by a glue layer, and the other side of the PET film layer is coated with a hot-melt glue layer; the preparation method thereof comprises sizing and laminating, curing, slitting and winding formation. The single-sided hot-melt aluminum-plastic composite foil of the invention has characteristics that one side is conducting and the other side is insulating, and the insulating side is coated with the hot-melt glue, which improves its extension capacity and makes it not easy to break, the extension strength is much higher than the national standard, and wrapping thinner wires with such single-sided hot-melt aluminum-plastic composite foil can improve insulating and shielding effects of various wires.

### TECHNICAL FIELD

The following relates to a single-sided hot-melt aluminum-plastic composite foil and a preparation method thereof

### BACKGROUND

Commercially-available thick cables generally contain a plurality of thin wires, which are compactly wrapped up and separated from each other with a thin layer of insulation skin. If partial insulation skin is damaged due to inattention during use, the whole wire may have a problem and even burn out. In order to avoid above problems, there is a need to wrap each thinner wires with a layer of protective films when fabricating such wires. This protective film is usually a film with one side being conducting and the other side being insulating, this protective film has a large coil diameter when it is finally wound during production, which brings inconvenience to production, meanwhile there is a need to equip a tape inverter, for handling the protective film coils which may have a bad winding formation or parallel rewinding of the film coils into portable forms.

### SUMMARY OF THE INVENTION

In order to solve technical problems described above, the following provides a single-sided hot-melt aluminum-plastic composite foil and a preparation method thereof, the single-sided hot-melt aluminum-plastic composite foil has characteristics that one side is conducting and the other side is insulating, and the insulating side is coated with the hot-melt glue and has characteristics of good shielding effect, waterproofing and improving its extension capacity, and the preparation method has advantages of saving processes, ease of operating, high efficiency and stable quality of produced products.

The single-sided hot-melt aluminum-plastic composite foil comprises an aluminum foil layer which has a thickness of 9-10 μm and a PET film layer which has a thickness of 10-20 μm, the aluminum foil layer and the PET film layer are bonded by a glue layer which has a thickness of 3-5 μm, and the other side of the PET film layer is coated with a hot-melt glue layer which has a thickness of 2-5 μm; the glue layer comprises glue, curing agent, diluent and paint, and the ratio of the glue, the curing agent, the diluent and the paint is glue:curing agent:diluent:paint=1:0.1-0.2:0.8-1.8:0.2-0.5.

The single-sided hot-melt aluminum-plastic composite foil provided in the present technical solution has an aluminum foil layer, a PET film layer and a hot-melt glue layer, wherein the aluminum foil layer and the PET film layer are bonded by the glue layer, this structure of the single-sided hot-melt aluminum-plastic composite foil renders it to have one side being conducting (the aluminum foil layer) and the other side being insulating (the PET film layer), because it is coated with a hot-melt glue layer, it is rendered stronger extension capacity, and wrapping wires with such composite foil can improve shielding effect, and has the functions of waterproofing and reinforcement; the paint has characteristics of being beautiful and easy to distinguish orientations.

Further, components of the glue comprise adipic acid, isophthalic acid, diglycol and ethyl acetate; components of the curing agent comprise TDI, trimethylol propane and ethyl acetate; the diluent is acetate; the ratio of the components of the glue is adipic acid:isophthalic acid:diglycol:ethyl acetate=2:1:2:5; the ratio of the components of the curing agent is TDI: trimethylol propane:ethyl acetate=3.5:1.5:5.

Further, the preparation method of the single-sided hot-melt aluminum-plastic composite foil comprises the steps:

1) putting the aluminum foil and the PET film on an aluminum foil roller and a PET film roller of a first dry laminating machine, drawing the aluminum foil and the PET film to allow one side of the aluminum foil and one side of the PET film to pass through a first glue bucket containing liquid glue, and then bonding the aluminum foil and the PET film smeared with the liquid glue layer through an extrusion roller to form a first semi-finished product;

2) drying the first semi-finished product made in the step 1) through a first drying tunnel of the first dry laminating machine, wherein the first drying tunnel has 4 heating zones inside, in which the temperature of every heating zone is 50-60° C.;

3) bringing the first semi-finished product dried in the step 2) into a first discharge shaft to collect the first semi-finished product coils;

4) putting the first semi-finished product coils obtained in the step 3) into an oven to dry, wherein the temperature of the oven is 55-60° C., and the time for drying is 48 h;

5) putting the first semi-finished product coils dried in the step 4) onto a semi-finished product roller of a second dry laminating machine, drawing one side of the first semi-finished product to pass through a second glue bucket containing liquid hot-melt glue, and smearing one side of the first semi-finished product with the liquid hot-melt glue;

6) drying the first semi-finished product smeared with the liquid hot-melt glue in the step 5) through a second drying tunnel of a second dry laminating machine, wherein the second drying tunnel has 4 heating zones inside, in which the temperature of the first two heating zones is 55-65° C., and heaters in the latter two heating zones are turned off;

7) bringing the first semi-finished product dried in the step 6) into a second discharge shaft to collect the second semi-finished product coils;

8) bringing the second semi-finished product coils obtained in the step 7) into a slitter to slit to a desired width;

9) bringing the second semi-finished product slit in the step 8) into a multi-head winder to parallel wind into finished product coils;

10) putting the finished product coils below standard in the step 9) into a single-head winder to unwind and then rewind parallel into finished product coils.

The preparation method of the present technical solution is first to bond the aluminum foil layer and the PET film layer by the glue layer, heat and cure, then adhere a hot-melt glue layer, dry the hot-melt glue and then wind and slit, followed by parallel winding the slit semi-finished product into the finished product coils by a multi-head winder, removing if the winding effect is poor, inverting the tape on a single-head winder and parallel rewinding into the finished product coils; wherein the temperature of the first drying tunnel and the second drying tunnel is beneficial to volatilization of the liquid glue layer or solvent substances of the liquid hot-melt glue layer, and the temperature and time of the oven are beneficial to curing of the glue layer.

Further, the multi-head winder in the step 9) includes a first machine cabinet, a plurality of first spindles and a plurality of first reciprocating mechanisms are mounted on the first machine cabinet, the first spindles and the first reciprocating mechanisms operate cooperatively, a first tension arm is movably mounted on a movable channel of the first reciprocating mechanism, and the other end of the first tension arm is in contact with the first spindle through a first arm roll shaft mounted on the first tension arm; the first machine cabinet is also mounted with a plurality of first tension rockers cooperatively used with the first spindles, and the first tension rockers are mounted with first roker roll shafts capable of moving along the first tension rockers; a plurality of first guide wheels are mounted on the first machine cabinet, and the first guide wheels are connected with the first roker roll shafts through winding objects; a first HMI operation screen is also mounted on the first machine cabinet.

The multi-head winder of the present technical solution has the roles of simultaneously winding a plurality of winding objects, and parallel winding the winding objects and rendering the formed finished product coils to have small volumes for better portability.

Further, the numbers of the spindles, the reciprocating mechanisms, the tension rockers and the guide wheels are the same; the guide wheels are mounted on the top of the electric cabinet.

Further, the single-head winder in the step 10) includes a second machine cabinet, and the second machine cabinet is mounted with a second upper spindle, a second lower spindle, a second upper tension rocker, a second lower tension rocker, a second reciprocating mechanism and a second guide roller, the second upper spindle operates cooperatively with the second upper tension rocker and the second reciprocating mechanism, a second tension arm is movably mounted on a movable channel of the second reciprocating mechanism, and the other end of the second tension arm is in contact with the second upper spindle through a second arm roll shaft mounted on the second tension arm, and the second upper tension rocker is mounted with a second upper roker roll shaft capable of moving along the second upper tension rocker; the second lower spindle operates cooperatively with the second lower tension rocker and the second guide roller, and the second lower tension rocker is mounted with a second lower roker roll shaft capable of moving along the second lower tension rocker; the second machine cabinet is also mounted with a second upper guide wheel, a second lower guide wheel and a second guide wheel set connecting the second upper guide wheel and the second lower guide wheel, the second upper guide wheel is connected with the second upper roker roll shaft through winding objects, and the second lower guide wheel is connected with the second lower roker roll shaft through winding objects; a second HMI operation screen is also mounted on the second machine cabinet.

The single-head winder of the present technical solution has the roles of inverting tape and parallel winding, can invert and parallel rewind the finished product coils which are not wound well in the multi-head winder, and can also invert and parallel rewind the spindle ever wound by the winder, and render the formed finished product coils to have advantages of small volumes for better portability.

Further, the second guide wheel set includes more than three guide wheels.

The single-sided hot-melt aluminum-plastic composite foil of the invention has characteristics that one side is conducting and the other side is insulating, and the insulating side is coated with the hot-melt glue, which improves its extension capacity and makes it not easy to break, the extension strength is much higher than the national standard, and wrapping thinner wires with the single-sided hot-melt aluminum-plastic composite foil and wrapping these wires with the cable insulation skin can improve insulating and shielding effects of various wires, and has the functions of waterproofing and reinforcement; the preparation method of the invention has effects of saving processes, ease of use, reduced production cost, improved benefit and stable quality, directly utilizes a multi-head winder or a single-head winder to parallel wind, and renders the resulting single-sided hot-melt aluminum-plastic composite foil to have reduced volume and improved portability.

### BRIEF DESCRIPTION OF THE DRAWINGS

Some of the embodiments will be described in detail, with reference to the following figures, wherein like designations denote like members, wherein:

FIG. 1 is a structural schematic diagram of a single-sided hot-melt aluminum-plastic composite foil of the invention;

FIG. 2 is a structural schematic diagram of the preparation method of Embodiment 1;

FIG. 3 is a structural schematic diagram of the preparation method of Embodiment 2 or 3;

FIG. 4 is a structural schematic diagram of a multi-head winder; and

FIG. 5 is a structural schematic diagram of a single-head winder.

### DESCRIPTION OF THE PREFERRED EMBODIMENTS

In order to readily understand the technical means realized in the invention, creative features, achieved goals and efficacies, the invention will be further elaborated in conjunction with specific embodiments, below.

### Embodiment 1

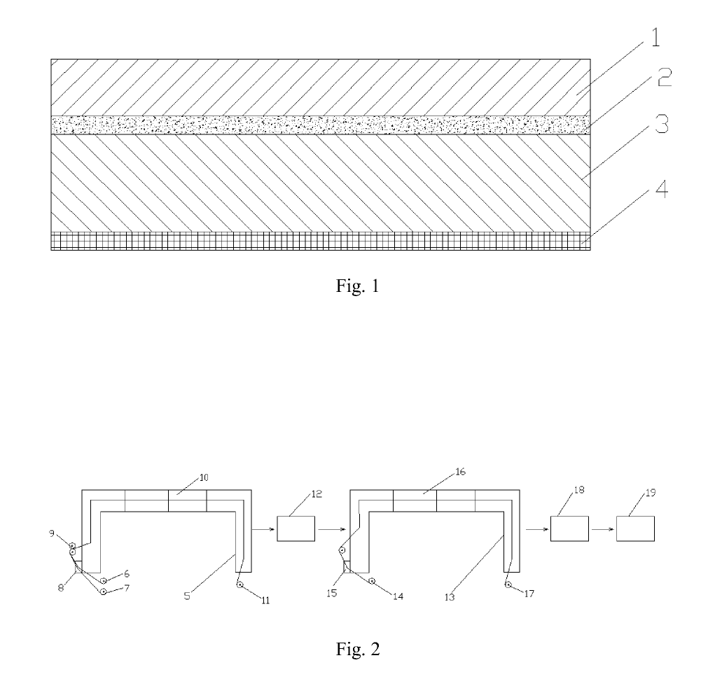

As shown in FIGS. 1 and 2, a single-sided hot-melt aluminum-plastic composite foil comprises an aluminum foil layer 1 and a PET film layer 3, the aluminum foil layer 1 and the PET film layer 3 are bonded by a glue layer 2, and the other side of the PET film layer 3 is coated with a hot-melt glue layer 4; the thickness of the aluminum foil layer 1 is 9 μm, the thickness of the PET film layer 3 is 10 μm, the thickness of the glue layer 2 is 3 μm, and the thickness of the hot-melt glue layer 4 is 2 μm; the glue layer 2 comprises glue, curing agent, diluent and paint, and the ratio of the glue, the curing agent, the diluent and the paint is glue:curing agent:diluent:paint=1:0.1:0.8:0.2; the ratio of the components of the glue is adipic acid:isophthalic acid:diglycol:ethyl acetate=2:1:2:5; the ratio of the components of the curing agent is TDI: trimethylol propane: ethyl acetate=3.5:1.5:5; the diluent is acetate.

A preparation method of the single-sided hot-melt aluminum-plastic composite foil comprises the steps:

1) putting the aluminum foil and the PET film on an aluminum foil roller 6 and a PET film roller 7 of a first dry laminating machine 5, drawing the aluminum foil and the PET film to allow one side of the aluminum foil and one side of the PET film to pass through a first glue bucket 8 containing liquid glue, and then bonding the aluminum foil and the PET film smeared with the liquid glue layer through an extrusion roller 9 to form a first semi-finished product;

2) drying the first semi-finished product made in the step 1) through a first drying tunnel 10 of the first dry laminating machine 5, wherein the first drying tunnel 10 has 4 heating zones inside, in which the temperature of every heating zone is 50° C.;

3) bringing the first semi-finished product dried in the step 2) into a first discharge shaft 11 to collect the first semi-finished product coils;

4) putting the first semi-finished product coils obtained in the step 3) into an oven 12 to dry, wherein the temperature of the oven 12 is 55° C., and the time for drying is 48 h;

5) putting the first semi-finished product coils dried in the step 4) onto a semi-finished product roller 14 of a second dry laminating machine 13, drawing one side of the first semi-finished product to pass through a second glue bucket 15 containing liquid hot-melt glue, and smearing one side of the first semi-finished product with the liquid hot-melt glue;

6) drying the first semi-finished product smeared with the liquid hot-melt glue in the step 5) through a second drying tunnel 16 of a second dry laminating machine 13, wherein the second drying tunnel 16 has 4 heating zones inside, in which the temperature of the first two heating zones is 55° C., and heaters in the latter two heating zones are turned off;

7) bringing the first semi-finished product dried in the step 6) into a second discharge shaft 17 to collect the second semi-finished product coils;

8) bringing the second semi-finished product coils obtained in the step 7) into a slitter 18 to slit to a desired width;

9) bringing the second semi-finished product slit in the step 8) into a multi-head winder 19 to parallel wind into finished product coils.

The multi-head winder 19 of the step 9) (see FIG. 4) includes a first machine cabinet 29, a plurality of first spindles 21 and a plurality of first reciprocating mechanisms 22 are mounted on the first machine cabinet 29, the first spindles 21 and the first reciprocating mechanisms 22 operate cooperatively, a first tension arm 23 is movably mounted on a movable channel of the first reciprocating mechanism 22, and the other end of the first tension arm 23 is in contact with the first spindle 21 through a first arm roll shaft 24 mounted on the first tension arm 23; the first machine cabinet 29 is also mounted with a plurality of first tension rockers 25 cooperatively used with the first spindles 21, and the first tension rockers 25 are mounted with first roker roll shafts 26 capable of moving along the first tension rockers 25; a plurality of first guide wheels 27 are mounted on the top of the first machine cabinet 29, and the first guide wheels 27 are connected with the first roker roll shafts 26 through winding objects; a first HMI operation screen 28 is also mounted on the first machine cabinet 29. The numbers of the spindles 21, the reciprocating mechanisms 22, the first tension rockers 25 and the first guide wheels 27 are the same.

A single-sided hot-melt aluminum-plastic composite foil of this Embodiment has characteristics that one side is conducting and the other side is insulating, and the insulating side is coated with the hot-melt glue, which improves its extension capacity and makes it not easy to break, the extension strength is much higher than the national standard, and wrapping thinner wires with the single-sided hot-melt aluminum-plastic composite foil and wrapping these wires with the cable insulation skin can improve insulating and shielding effects of various wires, and has the functions of waterproofing and reinforcement; the preparation method of the invention has effects of saving processes, ease of use, reduced production cost, improved benefit and stable quality, directly utilizes a multi-head winder or a single-head winder to parallel wind, and renders the resulting single-sided hot-melt aluminum-plastic composite foil to have reduced volume and improved portability.

### Embodiment 2

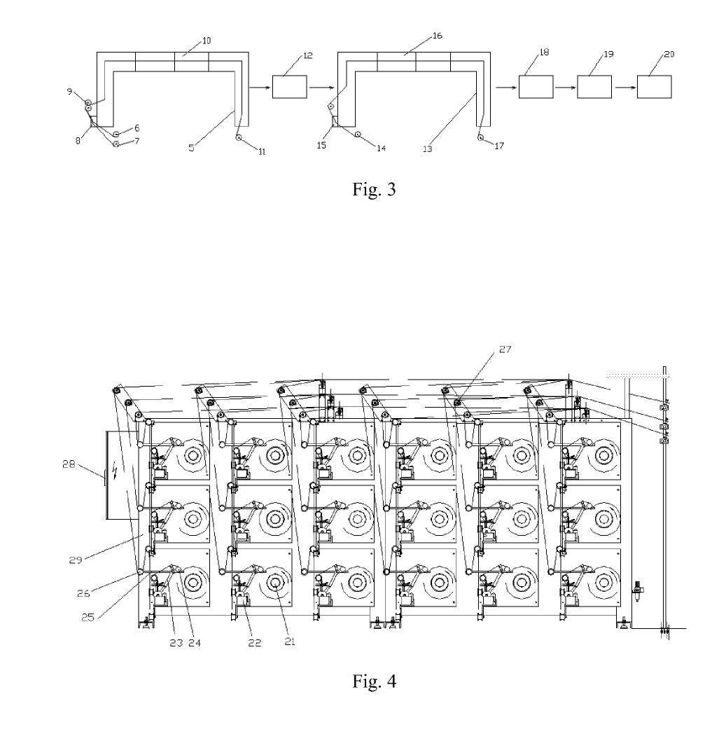

As shown in FIGS. 1 and 3, a single-sided hot-melt aluminum-plastic composite foil comprises an aluminum foil layer 1 and a PET film layer 3, the aluminum foil layer 1 and the PET film layer 3 are bonded by a glue layer 2, and the other side of the PET film layer 3 is coated with a hot-melt glue layer 4; the thickness of the aluminum foil layer 1 is 10 μm, the thickness of the PET film layer 3 is 20 μm, the thickness of the glue layer 2 is 5 μm, and the thickness of the hot-melt glue layer 4 is 5 μm; the glue layer 2 comprises glue, curing agent, diluent and paint, and the ratio of the glue, the curing agent, the diluent and the paint is glue:curing agent:diluent:paint=1:0.2:1.8:0.5; the ratio of the components of the glue is adipic acid: isophthalic acid:diglycol:ethyl acetate=2:1:2:5; the ratio of the components of the curing agent is TDI:trimethylol propane:ethyl acetate =3.5:1.5:5; the diluent is acetate.

A preparation method of the single-sided hot-melt aluminum-plastic composite foil comprises the steps:

1) putting the aluminum foil and the PET film on the aluminum foil roller 6 and the PET film roller 7 of the first dry laminating machine 5, drawing the aluminum foil and the PET film to allow one side of the aluminum foil and one side of the PET film to pass through a first glue bucket 8 containing liquid glue layer, and then bonding the aluminum foil and the PET film smeared with the liquid glue layer through an extrusion roller 9 to form a first semi-finished product;

2) drying the first semi-finished product made in the step 1) through a first drying tunnel 10 of the dry laminating machine 5, wherein the first drying tunnel 10 has 4 heating zones inside, in which the temperature of every heating zone is 60° C.;

3) bringing the first semi-finished product dried in the step 2) into a first discharge shaft 11 to collect the first semi-finished product coils;

4) putting the first semi-finished product coils obtained in the step 3) into an oven 12 to dry, wherein the temperature of the oven 12 is 60° C., and the time for drying is 48 h;

5) putting the first semi-finished product coils dried in the step 4) onto a semi-finished product roller 14 of a second dry laminating machine 13, drawing one side of the first semi-finished product to pass through a second glue bucket 15 containing liquid hot-melt glue, and smearing one side of the first semi-finished product with the liquid hot-melt glue;

6) drying the first semi-finished product smeared with the liquid hot-melt glue in the step 5) through a second drying tunnel 16 of a second dry laminating machine 13, wherein the second drying tunnel 16 has 4 heating zones inside, in which the temperature of the first two heating zones is 65° C., and heaters in the latter two heating zones are turned off;

7) bringing the first semi-finished product dried in the step 6) into a second discharge shaft 17 to collect the second semi-finished product coils;

8) bringing the second semi-finished product coils obtained in the step 7) into a slitter 18 to slit to a desired width;

9) bringing the second semi-finished product slit in the step 8) into a multi-head winder 19 to parallel wind into finished product coils;

10) putting the finished product coils below standard in the step 9) into a single-head winder 20 to unwind and then rewind parallel into finished product coils.

The multi-head winder 19 of the step 9) (see FIG. 4) includes a first machine cabinet 29, a plurality of first spindles 21 and a plurality of first reciprocating mechanisms 22 are mounted on the first machine cabinet 29, the first spindles 21 and the first reciprocating mechanisms 22 operate cooperatively, a first tension arm 23 is movably mounted on a movable channel of the first reciprocating mechanism 22, and the other end of the first tension arm 23 is in contact with the first spindle 21 through a first arm roll shaft 24 mounted on the first tension arm 23; the first machine cabinet 29 is also mounted with a plurality of first tension rockers 25 cooperatively used with the first spindles 21, and the first tension rockers 25 are mounted with first roker roll shafts 26 capable of moving along the first tension rockers 25; a plurality of first guide wheels 27 are mounted on the top of the first machine cabinet 29, and the first guide wheels 27 are connected with the first roker roll shafts 26 through winding objects; a first HMI operation screen 28 is also mounted on the first machine cabinet 29. The numbers of the spindles 21, the reciprocating mechanisms 22, the first tension rockers 25 and the first guide wheels 27 are the same.

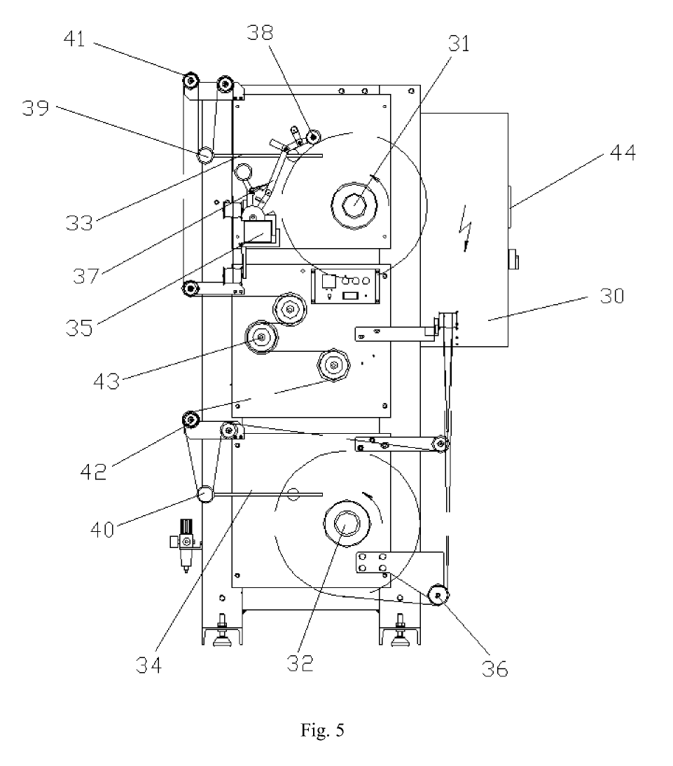

The single-head winder 20 of the step 10) (see FIG. 5) includes a second machine cabinet 30, and the second machine cabinet 30 is mounted with a second upper spindle 31, a second lower spindle 32, a second upper tension rocker 33, a second lower tension rocker 34, a second reciprocating mechanism 35 and a second guide roller 36, the second upper spindle 31 operates cooperatively with the second upper tension rocker 33 and the second reciprocating mechanism 35, a second tension arm 37 is movably mounted on a movable channel of the second reciprocating mechanism 35, and the other end of the second tension arm 37 is in contact with the second upper spindle 31 through a second arm roll shaft 38 mounted on the second tension arm 37, and the second upper tension rocker 33 is mounted with a second upper roker roll shaft 39 capable of moving along the second upper tension rocker 33; the second lower spindle 32 operates cooperatively with the second lower tension rocker 34 and the second guide roller 36, and the second lower tension rocker 34 is mounted with a second lower roker roll shaft 40 capable of moving along the second lower tension rocker 34; the second machine cabinet 30 is also mounted with a second upper guide wheel 41, a second lower guide wheel 42 and a second guide wheel set 43 connecting the second upper guide wheel 41 and the second lower guide wheel 42, the second upper guide wheel 41 is connected with the second upper roker roll shaft 39 through winding objects, and the second lower guide wheel 42 is connected with the second lower roker roll shaft 40 through winding objects; a second HMI operation screen 44 is also mounted on the second machine cabinet 30; the second guide wheel set 43 includes three guide wheels.

A single-sided hot-melt aluminum-plastic composite foil of this Embodiment has characteristics that one side is conducting and the other side is insulating, and the insulating side is coated with the hot-melt glue, which improves its extension capacity and makes it not easy to break, the extension strength is much higher than the national standard, and wrapping thinner wires with the single-sided hot-melt aluminum-plastic composite foil and wrapping these wires with the cable insulation skin can improve insulating and shielding effects of various wires, and has the functions of waterproofing and reinforcement; the preparation method of the invention has effects of saving processes, ease of use, reduced production cost, improved benefit and stable quality, directly utilizes a multi-head winder or a single-head winder to parallel wind, and renders the resulting single-sided hot-melt aluminum-plastic composite foil to have reduced volume and improved portability.

### Embodiment 3

As shown in FIGS. 1 and 3, a single-sided hot-melt aluminum-plastic composite foil comprises an aluminum foil layer 1 and a PET film layer 3, the aluminum foil layer 1 and the PET film layer 3 are bonded by a glue layer 2, and the other side of the PET film layer 3 is coated with a hot-melt glue layer 4; the thickness of the aluminum foil layer 1 is 9.5 μm, the thickness of the PET film layer 3 is 15 μm, the thickness of the glue layer 2 is 4 μm, and the thickness of the hot-melt glue layer 4 is 3 μm; the glue layer 2 comprises glue, curing agent, diluent and paint, and the ratio of the glue, the curing agent, the diluent and the paint is glue:curing agent:diluent:paint=1:0.15:1.2:0.3; the ratio of the components of the glue is adipic acid:isophthalic acid:diglycol:ethyl acetate=2:1:2:5; the ratio of the components of the curing agent is TDI:trimethylol propane:ethyl acetate=3.5:1.5:5; the diluent is acetate.

A preparation method of the single-sided hot-melt aluminum-plastic composite foil comprises the steps:

1) putting the aluminum foil and the PET film on an aluminum foil roller 6 and a PET film roller 7 of a first dry laminating machine 5, drawing the aluminum foil and the PET film to allow one side of the aluminum foil and one side of the PET film to pass through a first glue bucket 8 containing liquid glue layer, and then bonding the aluminum foil and the PET film smeared with the liquid glue layer through an extrusion roller 9 to form a first semi-finished product;

2) drying the first semi-finished product made in the step 1) through a first drying tunnel 10 of the dry laminating machine 5, wherein the first drying tunnel 10 has 4 heating zones inside, in which the temperature of every heating zone is 55° C.;

3) bringing the first semi-finished product dried in the step 2) into a first discharge shaft 11 to collect the first semi-finished product coils;

4) putting the first semi-finished product coils obtained in the step 3) into an oven 12 to dry, wherein the temperature of the oven 12 is 58° C., and the time for drying is 48 h;

5) putting the first semi-finished product coils dried in the step 4) onto a semi-finished product roller 14 of a second dry laminating machine 13, drawing one side of the first semi-finished product to pass through a second glue bucket 15 containing liquid hot-melt glue, and smearing one side of the first semi-finished product with the liquid hot-melt glue;

6) drying the first semi-finished product smeared with the liquid hot-melt glue in the step 5) through a second drying tunnel 16 of a second dry laminating machine 13, wherein the second drying tunnel 16 has 4 heating zones inside, in which the temperature of the first two heating zones is 60° C., and heaters in the latter two heating zones are turned off;

7) bringing the first semi-finished product dried in the step 6) into a second discharge shaft 17 to collect the second semi-finished product coils;

8) bringing the second semi-finished product coils obtained in the step 7) into a slitter 18 to slit to a desired width;

9) bringing the second semi-finished product slit in the step 8) into a multi-head winder 19 to parallel wind into finished product coils;

10) putting the finished product coils below standard in the step 9) into a single-head winder 20 to unwind and then rewind parallel into finished product coils.

The multi-head winder 19 of the step 9) (see FIG. 4) includes a first machine cabinet 29, a plurality of first spindles 21 and a plurality of first reciprocating mechanisms 22 are mounted on the first machine cabinet 29, the first spindles 21 and the first reciprocating mechanisms 22 operate cooperatively, a first tension arm 23 is movably mounted on a movable channel of the first reciprocating mechanism 22, and the other end of the first tension arm 23 is in contact with the first spindle 21 through a first arm roll shaft 24 mounted on the first tension arm 23; the first machine cabinet 29 is also mounted with a plurality of first tension rockers 25 cooperatively used with the first spindles 21, and the first tension rockers 25 are mounted with first roker roll shafts 26 capable of moving along the first tension rockers 25; a plurality of first guide wheels 27 are mounted on the top of the first machine cabinet 29, and the first guide wheels 27 are connected with the first roker roll shafts 26 through winding objects; a first HMI operation screen 28 is also mounted on the first machine cabinet 29. The numbers of the spindles 21, the reciprocating mechanisms 22, the first tension rockers 25 and the first guide wheels 27 are the same.

The single-head winder 20 of the step 10) (see FIG. 5) includes a second machine cabinet 30, and the second machine cabinet 30 is mounted with a second upper spindle 31, a second lower spindle 32, a second upper tension rocker 33, a second lower tension rocker 34, a second reciprocating mechanism 35 and a second guide roller 36, the second upper spindle 31 operates cooperatively with the second upper tension rocker 33 and the second reciprocating mechanism 35, a second tension arm 37 is movably mounted on a movable channel of the second reciprocating mechanism 35, and the other end of the second tension arm 37 is in contact with the second upper spindle 31 through a second arm roll shaft 38 mounted on the second tension arm 37, and the second upper tension rocker 33 is mounted with a second upper roker roll shaft 39 capable of moving along the second upper tension rocker 33; the second lower spindle 32 operates cooperatively with the second lower tension rocker 34 and the second guide roller 36, and the second lower tension rocker 34 is mounted with a second lower roker roll shaft 40 capable of moving along the second lower tension rocker 34; the second machine cabinet 30 is also mounted with a second upper guide wheel 41, a second lower guide wheel 42 and a second guide wheel set 43 connecting the second upper guide wheel 41 and the second lower guide wheel 42, the second upper guide wheel 41 is connected with the second upper roker roll shaft 39 through winding objects, and the second lower guide wheel 42 is connected with the second lower roker roll shaft 40 through winding objects; a second HMI operation screen 44 is also mounted on the second machine cabinet 30; the second guide wheel set 43 includes four guide wheels.

A single-sided hot-melt aluminum-plastic composite foil of this Embodiment has characteristics that one side is conductive and the other side is insulative, and the insulating side is coated with the hot-melt glue, which improves its extension capacity and makes it not easy to break, the extension strength is much higher than the national standard, and wrapping thinner wires with the single-sided hot-melt aluminum-plastic composite foil and wrapping these wires with the cable insulation skin can improve insulating and shielding effects of various wires, and has the functions of waterproofing and reinforcement; the preparation method of the invention has effects of saving processes, ease of use, reduced production cost, improved benefit and stable quality, directly utilizes a multi-head winder or a single-head winder to parallel wind, and renders the resulting single-sided hot-melt aluminum-plastic composite foil to have reduced volume and improved portability.

What is claimed is:

1. A single-sided hot-melt aluminum-plastic composite foil, wherein the single-sided hot-melt aluminum-plastic composite foil comprises an aluminum foil layer which has a thickness of 9-10 μm and a PET film layer which has a thickness of 10-20 μm, the aluminum foil layer and the PET film layer are bonded by a glue layer which has a thickness of 3-5 μm, and the other side of the PET film layer is coated with a hot-melt glue layer which has a thickness of 2-5 μm; the glue layer comprises glue, curing agent, diluent and paint, and the ratio of the glue, the curing agent, the diluent and the paint is glue:curing agent:diluent:paint=1:0.1-0.2:0.8-1.8:0.2-0.5.

2. The single-sided hot-melt aluminum-plastic composite foil according to claim 1, wherein: components of the glue comprise adipic acid, isophthalic acid, diglycol and ethyl acetate; components of the curing agent comprise TDI, trimethylol propane and ethyl acetate; the diluent is acetate; the ratio of the components of the glue is adipic acid:isophthalic acid:diglycol:ethyl acetate=2:1:2:5; the ratio of the components of the curing agent is TDI:trimethylol propane:ethyl acetate=3.5:1.5:5.

3. A preparation method of the single-sided hot-melt aluminum-plastic composite foil, wherein, the steps are:
1) putting a aluminum foil and a PET film on an aluminum foil roller and a PET film roller of a first dry laminating machine, drawing the aluminum foil and the PET film to allow one side of the aluminum foil and one side of the PET film to pass through a first glue bucket containing liquid glue, and then bonding the aluminum foil and the PET film smeared with a liquid glue layer through an extrusion roller to form a first semi-finished product;
2) drying the first semi-finished product made in the step 1) through a first drying tunnel of the first dry laminating machine, wherein the first drying tunnel has 4 heating zones inside, in which the temperature of every heating zone is 50-60° C.;
3) bringing the first semi-finished product dried in the step 2) into a first discharge shaft to collect the first semi-finished product coils;
4) putting the first semi-finished product coils obtained in the step 3) into an oven to dry, wherein the temperature of the oven is 55-60° C., and the time for drying is 48 h;
5) putting the first semi-finished product coils dried in the step 4) onto a semi-finished product roller of a second dry laminating machine, drawing one side of the first semi-finished product to pass through a second glue bucket containing liquid hot-melt glue, and smearing one side of the first semi-finished product with the liquid hot-melt glue;
6) drying the first semi-finished product smeared with the liquid hot-melt glue in the step 5) through a second drying tunnel of a second dry laminating machine, wherein the second drying tunnel has 4 heating zones inside, in which the temperature of the first two heating zones is 55-65° C., and heaters in the latter two heating zones are turned off;
7) bringing the first semi-finished product dried in the step 6) into a second discharge shaft to collect the second semi-finished product coils;
8) bringing the second semi-finished product coils obtained in the step 7) into a slitter to slit to a desired width;
9) bringing the second semi-finished product slit in the step 8) into a multi-head winder to parallel wind into finished product coils;
10) putting the finished product coils below standard in the step 9) into a single-head winder to unwind and then rewind parallel into finished product coils.

4. The preparation method of the single-sided hot-melt aluminum-plastic composite foil according to claim 3, wherein: the multi-head winder in the step 9) includes a first machine cabinet, a plurality of first spindles and a plurality of first reciprocating mechanisms are mounted on the first machine cabinet, the first spindles and the first reciprocating mechanisms operate cooperatively, a first tension arm is movably mounted on a movable channel of the first reciprocating mechanism, and the other end of the first tension arm is in contact with the first spindle through a first arm roll shaft mounted on the first tension arm; the first machine cabinet is also mounted with a plurality of first tension rockers cooperatively used with the first spindles, and the first tension rockers are mounted with first roker roll shafts capable of moving along the first tension rockers; a plurality of first guide wheels are mounted on the first machine cabinet, and the first guide wheels are connected with the first roker roll shafts through winding objects; a first HMI operation screen is also mounted on the first machine cabinet.

5. The preparation method of the single-sided hot-melt aluminum-plastic composite foil according to claim 4, wherein: the numbers of the spindles, the reciprocating mechanisms, the tension rockers and the guide wheels are the same; the guide wheels are mounted on the top of the first machine cabinet.

6. The preparation method of the single-sided hot-melt aluminum-plastic composite foil according to claim 3, wherein: the single-head winder in the step 10) includes a second machine cabinet, and the second machine cabinet is mounted with a second upper spindle, a second lower spindle, a second upper tension rocker, a second lower tension rocker, a second reciprocating mechanism and a second guide roller, the second upper spindle operates cooperatively with the second upper tension rocker and the second reciprocating mechanism, a second tension arm is movably mounted on a movable channel of the second reciprocating mechanism, and the other end of the second tension arm is in contact with the second upper spindle through a second arm roll shaft mounted on the second tension arm, and the second upper tension rocker is mounted with a second upper roker roll shaft capable of moving along the second upper tension rocker; the second lower spindle operates cooperatively with the second lower tension rocker and the second guide roller, and the second lower tension rocker is mounted with a second lower roker roll shaft capable of moving along the second lower tension rocker; the second machine cabinet is also mounted with a second upper guide wheel, a second lower guide wheel and a second guide wheel set connecting the second upper guide wheel and the second lower guide wheel, the second upper guide wheel is connected with the second upper roker roll shaft through winding objects, and the second lower guide wheel is connected with the second lower roker roll shaft through winding objects; a second HMI operation screen is also mounted on the second machine cabinet.

7. The preparation method of the single-sided hot-melt aluminum-plastic composite foil according to claim 6, wherein: the second guide wheel set includes more than three guide wheels.
